(19) United States
(12) Patent Application Publication
(10) Pub. No.: US 2026/0277633 A1
(43) Pub. Date: Sep. 17, 2026

(54) METHOD AND APPARATUS FOR REFRESHING INTERFACE, DEVICE AND PRODUCT

(71) Applicant: Beijing Zitiao Network Technology Co., Ltd., Beijing (CN)

(72) Inventor: Honghao ZENG, Beijing (CN)

(21) Appl. No.: 19/541,121

(22) Filed: Feb. 16, 2026

(30) Foreign Application Priority Data
Mar. 14, 2025 (CN) 202510307615.7

(51) Int. Cl. G06F 9/451; G11B 27/031

(52) U.S. Cl. CPC G06F 9/451; G11B 27/031

(57) ABSTRACT

The present disclosure relates to a method and an apparatus for refreshing an interface, a device, and a product. The method includes determining, in response to detecting a user’s interactive operation for a first interface, first data, the first interface being used for editing an audio-and-video, and the first data indicating data for refreshing the first interface and corresponding to the interactive operation. The method includes generating second data based on the first data and model data of the audio-and-video. The method includes refreshing the first interface based on the second data , the refreshed first interface being a second interface. In addition, the method further includes displaying the edited audio-and-video on the second interface.

### CROSS-REFERENCE TO RELATED APPLICATION(S)

The present disclosure claims the priority from the CN patent application No. 202510307615.7 entitled “Method and apparatus for refreshing interface, device and product” filed with the China National Intellectual Property Administration (CNIPA) on Mar. 14, 2025, the contents of which are hereby incorporated by reference in their entirety.

### FIELD

The present disclosure relates to the field of computers and, in particular, to a method and an apparatus for refreshing an interface, a device, and a product.

### BACKGROUND

With the rapid development of media content publishing platforms, users’ demand for media content editing has grown. For example, in the field of audio-and-video, to satisfy users’ needs, audio-and-video editing software has been created, allowing users to perform processing such as clipping, concatenating, adjusting, effect adding, and audio mixing on recorded or existing audio-and-video materials, thereby creating audio-and-video works that meet their needs. In the process of creation, a draft audio-and-video editing interface may play a key role, allowing users to edit and adjust an unfinished audio-and-video project, thereby producing the audio-and-video content they need.

### SUMMARY

In a first aspect of embodiments of the present disclosure, a method for refreshing an interface is provided. The method includes determining, in response to detecting a user’s interactive operation for a first interface, first data, the first interface being used for editing an audio-and-video, and the first data indicating data for refreshing the first interface and corresponding to the interactive operation. The method includes generating second data based on the first data and model data of the audio-and-video. The method includes refreshing the first interface based on the second data , the refreshed first interface being a second interface. In addition, the method further includes displaying the edited audio-and-video on the second interface.

In a second aspect of embodiments of the present disclosure, an apparatus for refreshing an interface is provided. The apparatus includes a first data determination module configured to determine, in response to detecting a user’s interactive operation for a first interface, first data, the first interface being used for editing an audio-and-video, and the first data indicating data for refreshing the first interface and corresponding to the interactive operation. The apparatus includes a second data generation module configured to generate second data based on the first data and model data of the audio-and-video. The apparatus includes a first interface refreshing module configured to refresh the first interface based on the second data , the refreshed first interface being a second interface. In addition, the apparatus further includes a displaying module configured to display the edited audio-and-video on the second interface.

In a third aspect of embodiments of the present disclosure, an electronic device is provided. The electronic device includes a processor and a memory coupled with the processor, the memory having instructions stored therein, the instructions, when executed by the processor, causing the electronic device to perform the method according to the first aspect.

In a fourth aspect of embodiments of the present disclosure, a computer program product is provided, having computer-executable instructions stored thereon, wherein the computer-executable instructions are executed by a processor to implement the method of the first aspect.

The Summary section is provided to introduce a selection of concepts in a simplified form, which will be further described in the Detailed Description section below. The Summary section is not intended to identify key features or essential features of the claimed subject matter, nor is it intended to limit the scope of the claimed subject matter.

### BRIEF DESCRIPTION OF THE DRAWINGS

The above and other features, advantages and aspects of embodiments of the present disclosure will become more apparent in combination with the drawings and with reference to the following Detailed Description section. In the drawings, the same or similar reference symbols refer to the same or similar elements, where:

FIG. 1 shows a schematic diagram of an example environment in which multiple embodiments of the present disclosure may be implemented;

FIG. 2 shows a flowchart of a method for refreshing an interface according to some embodiments of the present disclosure;

FIG. 3A - FIG. 3B show schematic diagrams of example interfaces for swapping video tracks according to some embodiments of the present disclosure;

FIG. 4 shows a schematic diagram of an example process for refreshing an editing interface according to some embodiments of the present disclosure;

FIG. 5 shows a block diagram of an apparatus for displaying a visual template package according to some embodiments of the present disclosure; and

FIG. 6 shows a block diagram of a device capable of implementing multiple embodiments of the present disclosure.

### DETAILED DESCRIPTION OF EMBODIMENTS

It may be understood that all user-related data involved in the technical solution should be acquired and used after user authorization. This means that in the technical solution, if the user's personal information needs to be used, the user's explicit consent and authorization are required before such data is acquired, otherwise, the relevant data collection and use will not be performed. It should also be understood that when implementing the technical solution, relevant laws and regulations should be strictly complied with in the process of data collection, use and storage, and necessary technical and administrative measures should be taken to protect the user's data security and ensure the secure use of data.

It may be understood that before using the technical solutions disclosed in the embodiments of the present disclosure, the user should be informed of the type, range of use, use scenarios, etc. of personal information involved in the present disclosure in an appropriate manner in accordance with relevant laws and regulations and the authorization of the user should be obtained.

For example, when a user's active request is received, prompt information is sent to the user to clearly inform the user that the requested operation will require access to and use of the user's personal information. In this way, the user may independently choose, based on the prompt information, whether to provide the personal information to software or hardware, such as an electronic device, an application, a server, or a storage medium, that performs the operations of the technical solutions of the present disclosure.

As an optional but non-limiting implementation, in response to receiving the user's active request, the prompt information may be sent to the user in the form of, for example, a pop-up window, in which the prompt information may be presented in text. In addition, the pop-up window may also include a selection control for the user to choose whether to "agree" or "disagree" to provide the personal information to the electronic device.

It may be understood that the above process of notifying and acquiring user authorization is only illustrative and does not limit the implementations of the present disclosure, and other manners that satisfy the relevant laws and regulations may also be applied in the implementations of the present disclosure.

Embodiments of the present disclosure will now be described in more detail with reference to the drawings. Although certain embodiments of the present disclosure are shown in the drawings, it should be understood that the present disclosure may be implemented in various forms and should not be construed as limited to the embodiments set forth herein; on the contrary, these embodiments are provided for a more thorough and complete understanding of the present disclosure. It should be understood that the drawings and embodiments of the present disclosure are only for exemplary purposes and are not intended to limit the scope of protection of the present disclosure.

In the description of the embodiments of the present disclosure, the term "include/comprise" and similar terms should be understood as open-ended inclusions, that is, "include/comprise but not limited to". The term "based on" should be understood as "at least partially based on". The term "an embodiment" or "the embodiment" should be understood as "at least one embodiment". The terms "first", "second", etc. may refer to different or same objects, unless explicitly stated. Other explicit and implicit definitions may also be included below.

As mentioned above, with the development of media content publishing platforms, users’ demand for media content editing has grown. Taking audio-and-video as an example, in the process of creation, users may adjust an unfinished audio-and-video project at an audio-and-video editing interface. It is a draft of the audio-and-video related to the audio-and-video editing interface that supports the display of the audio-and-video editing interface to users. This is because various rendering views presented by the audio-and-video editing interface are dynamically updated depending on draft data (which may also be referred to as model data) of the audio-and-video. The draft of the audio-and-video may drive a rendering engine of the audio-and-video to complete content rendering and finally display images to users.

In related technologies, users’ editing operations on audio-and-video (including related logical processing of the audio-and-video draft) are placed in a main thread of audio-and-video processing (for example, a thread where an interface of direct interaction of users with editing software is located). In view of the fact that users’ editing operations on audio-and-video in the process of creation are frequent events that need to be responded to, this method of placing operations in the main thread may cause the users’ editing interface to freeze, and may even lead to the situation of application not responding (ANR), affecting users’ experience of interaction with the editing interface.

To this end, at least in order to avoid the above and other potential situations, the present disclosure proposes a method for refreshing an interface, which may smoothly refresh the interface according to users’ frequent interactive operations. According to the embodiments of the present disclosure, when a user’s interactive operation for a first interface for audio-and-video editing is detected, first data including data for refreshing the first interface and corresponding to the interactive operation may be determined. Then, second data may be generated based on the first data and model data of the audio-and-video. After that, the first interface may be refreshed based on the second data, and the refreshed first interface is a second interface. Finally, the edited audio-and-video may be presented on the second interface.

Through this method, it may be ensured the stability and fluency of users’ interaction with the interface in the scenario of frequent interaction between users and the audio-and-video editing interface, so that users may be provided with a stable and high-quality editing environment. This method of avoiding the freezing of the editing interface also improves users' experience of interaction.

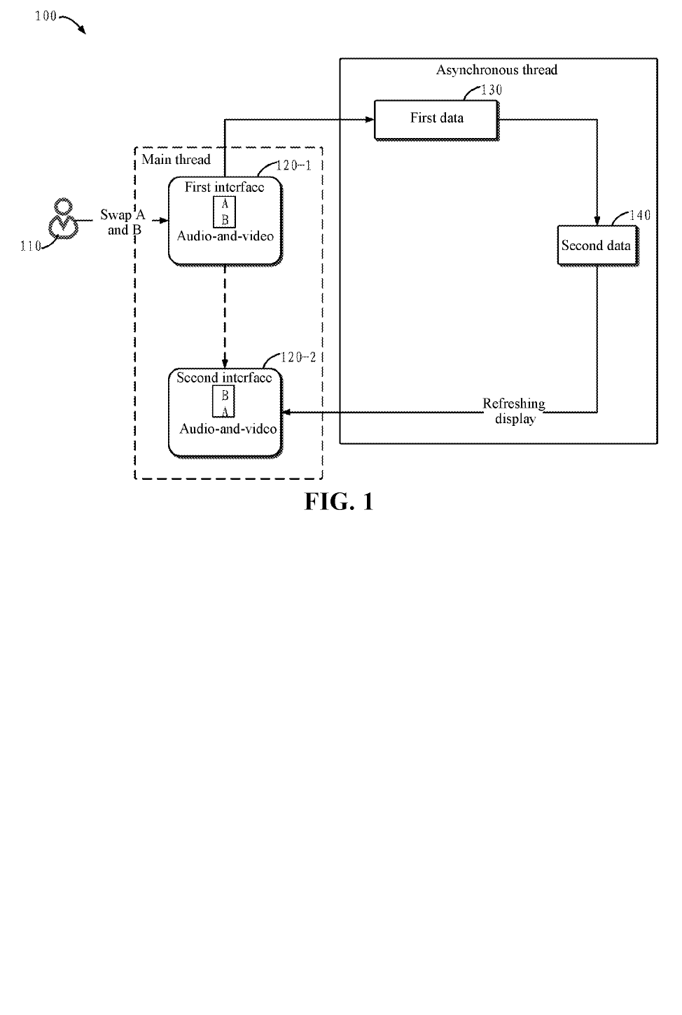

The embodiments of the present disclosure will be further described in detail below in combination with the drawings. FIG. 1 shows a schematic diagram of an example environment 100 in which multiple embodiments of the present disclosure may be implemented. As shown in FIG. 1, taking audio-and-video editing as an example, a user 110 may edit an audio-and-video on a first interface 120-1 displayed by a user device. For example, the user 110 may edit audio-and-video materials by directly performing touch operations on a screen of the user device or by using an external device such as a mouse or a keyboard. Thus, based on the user’s 110 interactive operation, the user device may display an updated second interface 120-2 in real time, and the second interface may display the audio-and-video edited by the user. For example, the user 110 may swap material A in the audio-and-video on the first interface 120-1 with another material B in the audio-and-video by dragging, so that the editing interface after the user's interaction may be smoothly displayed on the second interface 120-2, that is, material B and material A have swapped positions, while other interface elements on the interface are in a stable and unchanged state. In some embodiments, the materials may cover various types of materials such as audio, video, text, stickers, effects, transitions, filters, and adjustments.

In some embodiments, in order that the user’s 110 frequent editing operations on the first interface 120-1 displayed by the user device may be refreshed in real time, an operation thread for refreshing the editing interface (including draft logic of audio-and-video processing) may be independent of the main thread (for example, rendering audio-and-video) that requires a large amount of resources, so that the interface may be smoothly refreshed. That is to say, the thread for refreshing the interface may be independent of the main thread and implemented as a separate asynchronous thread. In this asynchronous thread, data for interface refreshing may be prepared, so that in the main thread, the editing interface may be refreshed directly according to the refreshing data, which may avoid interface freezing and even non-response.

In some embodiments, after the user’s 110 interactive operation is detected, the first data 130 for refreshing the first interface 120-1 and corresponding to the interactive operation may be acquired, the first data indicating the data for refreshing the first interface 120-1 corresponding to the user’s interactive operation. For example, if the user’s 110 interactive operation is to swap A and B, the first data related to the user’s interactive operation may be expressed as "swap positions, material A, material B". At the same time, the first data also includes the type of service request data related to the user’s interactive operation, for example, the type of the service request data may be "swap positions". Some other interactive operations may also be interactive actions such as "replacing" and "cropping".

In some embodiments, after the first data 130 related to the interactive operation is acquired, the second data 140 for refreshing the interface may be generated based on the first data 130, so that the refreshed second interface 120-2 may be displayed based on the second data 140 and the model data of the audio-and-video.

In some embodiments, the model data of the audio-and-video may be a set of comprehensive data associated with the editing process of the audio-and-video cached during the editing process of the audio-and-video, and the set of comprehensive data may include at least original data, editing data, metadata, and preview data of the audio-and-video.

In some embodiments, the second data is an incremental data structure. In some embodiments, the second data 140 may include a data structure of media material such as audio-and-video corresponding to the user’s interactive operation, so that when the editing interface is refreshed, the second interface 120-2 corresponding to the interactive operation may be rendered according to the corresponding data structure. For example, if the user’s interactive operation is to swap material A and material B, the generated second data 140 may be "there exist two resources, the first resource is material B, identified as B; the second resource is material A, identified as A". Then, the audio-and-video rendering module may render the refreshed second interface 120-2 based on the second data 140. After refreshing, the edited audio-and-video corresponding to the user’s interactive operation are displayed on the second page 120-2.

By means of the second data 140, the user device may quickly display the second interface 120-2 and complete the swapping of material A and material B. That is, on the second interface 120-2, the user may clearly see that material B and material A have swapped positions, and the transition of the entire interface is smooth and natural, without freezing or delay.

Through this method of transforming the user’s interactive operation into the first data indicating the data for refreshing the interface and then into the second data for refreshing, it may be ensured the stability and fluency of interaction of the editing interface in the scenario of frequent interaction between the user and the video editing interface, thereby providing the user with a stable and high-quality editing environment. By means of this method of double-transforming the interactive operation, the user experience is improved.

It may be understood that the user device may be any device that may accept input information, for example, a mobile phone, a tablet computer, a notebook computer, a palmtop computer, a smart television, a personal digital assistant (PDA), a smart printer, a smart home appliance, a vehicle-mounted terminal, a wearable device (a smart watch, a smart bracelet, a smart glasses, etc.), a virtual reality (VR) device, an augmented reality (AR) device, etc., which is not limited in the embodiments of the present application. It may be understood that the user device is configured with detection mechanisms such as various sensors and input interfaces, which may be used for capturing the user’s interactive operation.

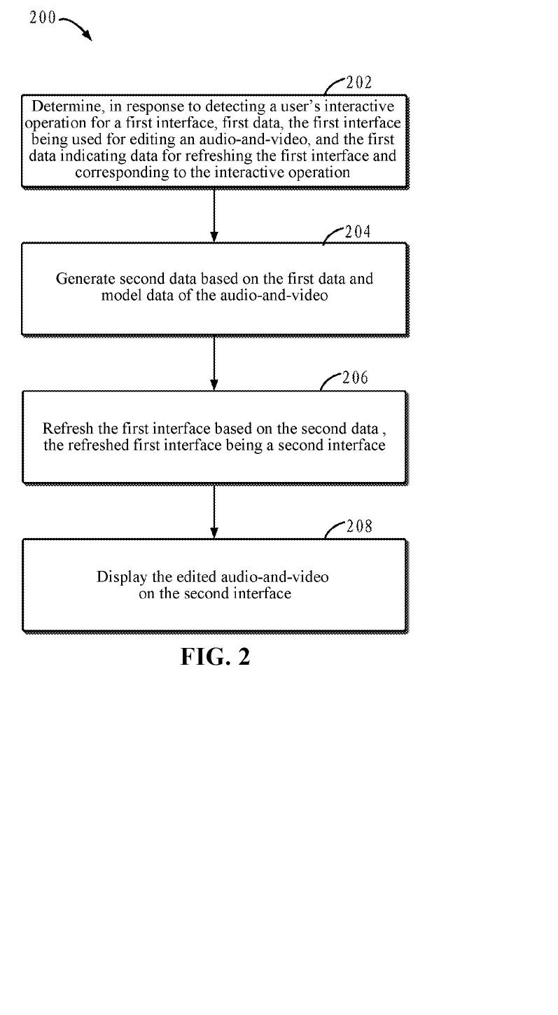

The method according to the embodiments of the present disclosure will be described in detail below with reference to FIG. 2 to FIG. 6. For ease of understanding, the specific data mentioned in the following description is exemplary and is not intended to limit the scope of protection of the present disclosure. It may be understood that the embodiments described below may further include additional actions not shown and/or may omit the actions shown, and the scope of the present disclosure is not limited in this respect.

FIG. 2 shows a flowchart of a method 200 for refreshing an interface according to some embodiments of the present disclosure. The method 200 may be performed by an apparatus for refreshing an interface, which for example may be an independent apparatus or system. The apparatus may be implemented by means of software and/or hardware. Next, the method 200 will be schematically described by taking the apparatus for refreshing an interface as an execution body as an example. The method 200 includes a block 202, a block 204, a block 206, and a block 208.

As shown in FIG. 2, at the block 202, first data is determined in response to detecting a user’s interactive operation for a first interface, the first interface being used for editing an audio-and-video, and the first data indicating data for refreshing the first interface and corresponding to the interactive operation. As shown in FIG. 1, taking audio-and-video editing as an example, a user 110 may edit an audio-and-video on a first interface 120-1 displayed by a user device. In some embodiments, after the user’s 110 interactive operation is detected, first data 130 related to the interactive operation may be acquired, the first data indicating data for refreshing the first interface 120-1 corresponding to the user’s interactive operation. For example, if the user’s 110 interactive operation is to swap A and B, the first data related to the user’s interactive operation may be expressed as "swap positions, material A, material B". In some embodiments, the first data includes the type of service request data related to the user’s interactive operation, for example, the type of the service request data may be "swap positions".

At the block 204, second data is generated based on the first data and model data of the audio-and-video. Referring to FIG. 1, in some embodiments, after the first data 130 related to the interactive operation is acquired, the second data 140 for refreshing the editing interface may be generated based on the first data 130 and the model data of the audio-and-video, so that the refreshed second interface 120-2 may be displayed based on the second data 140. In some embodiments, the model data of the audio-and-video may be draft data of the audio-and-video.

At the block 206, the first interface is refreshed based on the second data , the refreshed first interface being a second interface. Referring to FIG. 1, in some embodiments, when the second data 140 for refreshing the interface is acquired, the first interface 120-1 may be refreshed based on the second data 140, and the refreshed interface is the second interface 120-2.

At the block 208, the edited audio-and-video are displayed on the second interface. The unedited audio-and-video are displayed on the first interface 120-1, and after refreshing, the edited audio-and-video corresponding to the user’s interactive operation are displayed on the second interface 120-2.

Through this method of transforming the user’s interactive operation into the first data and then into the second data for refreshing, it may be ensured the stability and fluency of interaction of the editing interface in the scenario of frequent interaction between the user and the video editing interface, thereby providing the user with a stable and high-quality editing environment, and improving the user experience.

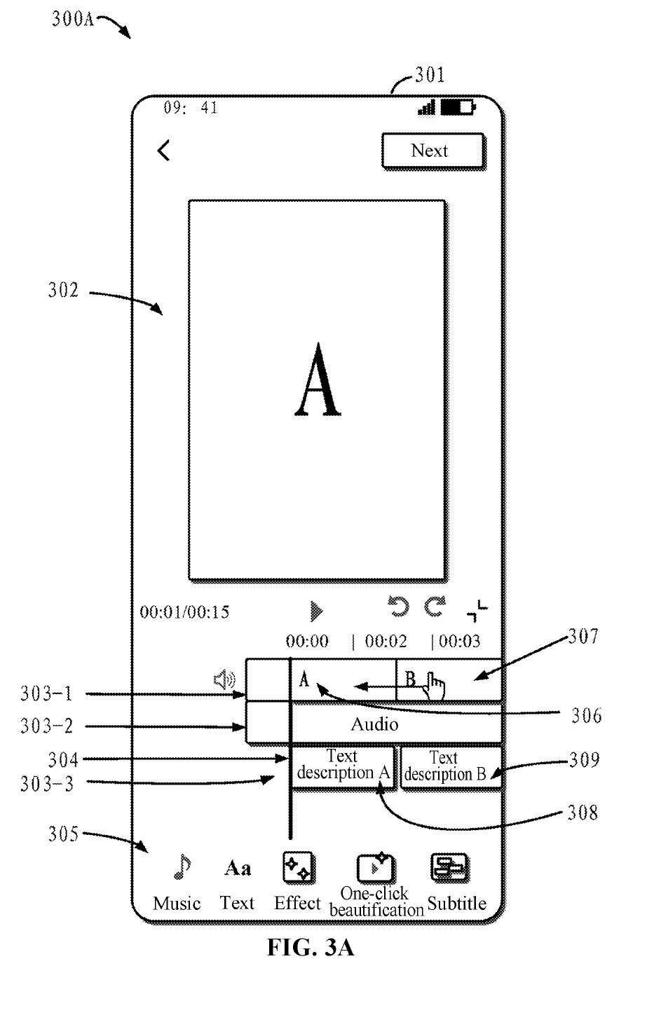

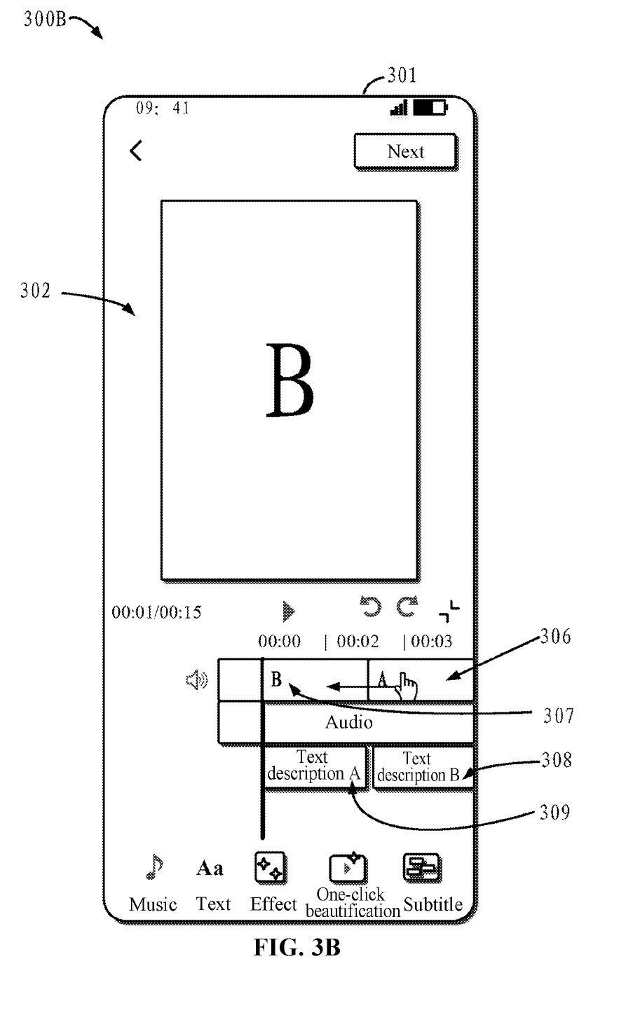

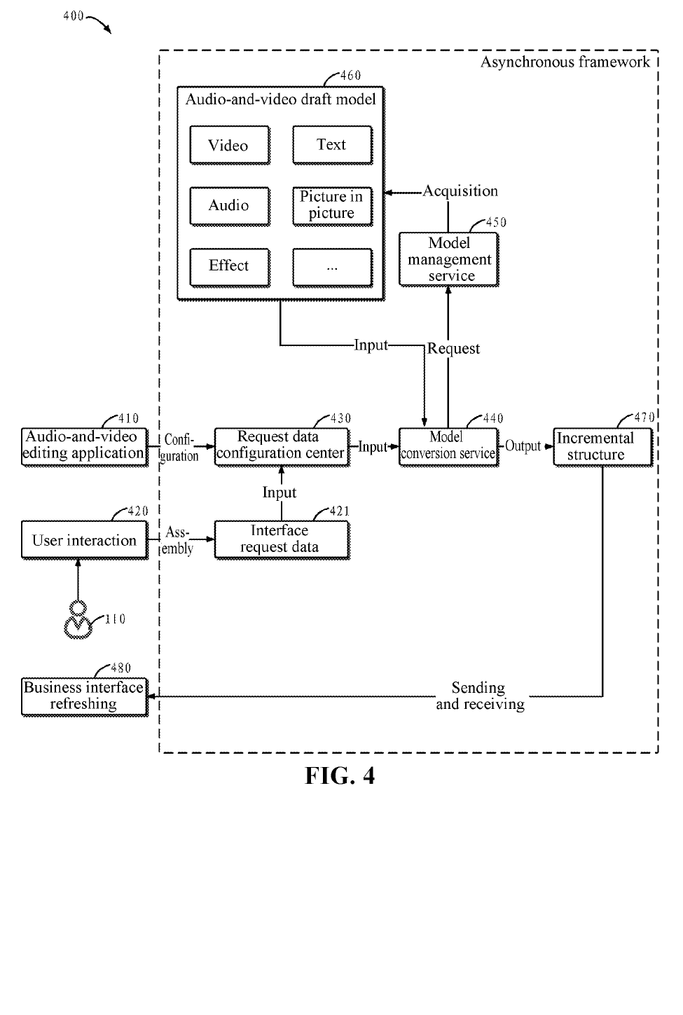

The schematic diagrams of the example environment and scenario in which the method of the embodiments of the present disclosure may be implemented are described above with reference to FIG. 1 and FIG. 2, and the method for refreshing an interface provided by the present disclosure will be described below with reference to FIG. 3A to FIG. 4. Taking audio-and-video editing as an example, in this scenario, the business process of audio-and-video editing is mainly triggered by user interaction. The user performs various operations on the editing interface, and subsequently, the interface will respond according to the user’s interactive behavior to implement interface refreshing.

FIG. 3A shows a schematic diagram of an example editing interface 300A for swapping video tracks according to some embodiments of the present disclosure. Referring to FIG. 3A, in the audio-and-video editing interface 301, an audio-and-video real-time preview area 302 (which may also be referred to as a player), a track editing area, and a function panel area 305 are arranged from top to bottom. The audio-and-video real-time preview area 302 supports clip preview, which allows the user to view the editing effect of the audio-and-video at any time during the audio-and-video editing process, and also supports operations such as proportion adjustment to meet the user’s need to publish the edited audio-and-video content. In the real-time preview area 302, the user may implement operations such as playing, pausing, fast forwarding, and rewinding of the audio-and-video to observe whether the audio-and-video satisfy the user in all perspectives.

As shown in FIG. 3A, the track editing area includes a video track 303-1, an audio track 303-2, and a picture-text/sticker track 303-3. In some embodiments, the track editing area may further include multiple tracks such as a filter track and an effect track to support the user’s complex editing needs. The track editing area may be linked with the real-time preview area 302, and when the user slides the playback head 304 on the track, the real-time preview area 302 may synchronously display the audio-and-video content at the time point where the playback head is located.

Referring to FIG. 3A, the bottom of the track editing area further includes a function/material panel area 305. In some embodiments, materials may cover various types of materials such as audio, video, text, stickers, effects, transitions, filters, and adjustments, and the user may find a wide variety of resources here, thereby adding interface elements for audio-and-video editing. In some embodiments, when the user selects a certain track in the track editing area, a corresponding function panel may also be invoked, for example, operations such as speed changing and intelligent beat matching may be performed, so as to facilitate the adjustment of details of the audio-and-video.

As shown in FIG. 3A, a main track clip 306 (video A) and a main track clip 307 (video B) are filled in the video track 303-1 in sequence from left to right, and texts linked with the two main track clips are a text description 308 and a text description 309, respectively. When the user selects the main track clip 307 and long-presses and moves it to the left to swap with the main track clip 306, the text description 309 linked with the main track clip 307 will also swap positions with the text description 308 linked with the main track clip 306, so that the editing interface 301 will be refreshed at this time.

FIG. 3B shows a schematic diagram of an example refreshed editing interface 300B for swapping video tracks according to some embodiments of the present disclosure. Referring to FIG. 3B, the editing interface 301 has an interface refreshing behavior. At this time, a main track clip 307 (video B) and a main track clip 306 (video A) are filled in the video track 303-1 from left to right, and the texts linked with the two main track clips are also moved accordingly.

The above FIG. 3A-3B describe the schematic diagrams of the example editing interface of the embodiments of the present disclosure, and the process for refreshing an interface of the embodiments of the present disclosure will be described below in combination with FIG. 4. FIG. 4 shows a schematic diagram of an example process 400 for refreshing an interface according to some embodiments of the present disclosure. The example process 400 may be performed by the apparatus for refreshing an interface.

As mentioned above, the interactive operation between the user and the editing interface is performed in the main thread, that is, the refreshing behavior of the editing interface, for example, the rendering of audio-and-video on the screen, is run in the main thread. It is the draft data or the (draft) model data of the audio-and-video that supports the rendering of various views on the interface.

In order to avoid that the related processing logic of the audio-and-video editing (draft) model data is placed in the main thread for operation, the related processing logic may be placed in a separate asynchronous framework for execution. In some embodiments, the asynchronous framework may be provided by the apparatus for refreshing an interface or may be customized by the user. In some embodiments, the asynchronous framework may be a multithreaded environment, which may provide a fast and concurrent access service. By processing the draft data of the audio-and-video through the asynchronous framework, the freezing phenomenon of the refreshed interface caused by the logic of processing the model data of the audio-and-video in the main thread may be effectively avoided, and the user experience is improved. For ease of description, the audio-and-video draft model in the following may be referred to as the model data or the model data of the audio-and-video, and the draft model also has the same meaning as the model data.

Referring to FIG. 4, in some embodiments, the audio-and-video editing application 410 may perform initialization configuration on the request data configuration center 430 in the asynchronous framework, so that when the user is in the audio-and-video editing interface, the real-time smooth refresh of the editing interface may be realized in the process of editing the audio-and-video.

In some embodiments, when the user 110 triggers user interaction 420, the apparatus for refreshing the editing interface may analyze the interactive operation triggered by the user 110 to determine the user’s interactive behavior, such as a "replacing behavior" or a "swapping behavior", etc. At the same time, the user’s 110 interactive operation may be assembled into the interface request data 421, that is, the first data mentioned above. In combination with the above description of FIG. 3A, when the user selects the main track clip 307 and long-presses and moves it to the left to trigger the swapping between the main track clip 307 and the main track clip 306, the interface request data 421 may be assembled and generated from the user interaction.

In some embodiments, the interface request data 421 may mainly include the type of service request data, and then the type is input into the request data configuration center 430 as input, and the request data configuration center 430 processes and transforms the service request data. In combination with the interactive description of FIG. 3A, the interface request data 421 may carry three contents: "swap positions, video A, and video B".

In some embodiments, the interface request data 421 may be expanded by the request data configuration center 430 into a behavior description and a material set. The behavior description represents the logic of user interaction corresponding to the user’s interactive behavior, and the interactive behavior shown in FIG. 3A is described as "swap positions". The material set represents the resource information operated by the behavior description. In the interactive behavior shown in FIG. 3A, the material set may include two pieces of resource information: "video A starting at the 0th second and ending at the 6th second; and video B starting at the 6th second and ending at the 15th second".

In some embodiments, the request data configuration center 430 may input the interface request data 421 into the model conversion service 440 to output an incremental structure 470 of the model data, that is, the second data. The incremental structure is a way to store and process data changes, which mainly focuses on the changed part of the data.

In some embodiments, the model conversion service 440 is a service used for transforming the data model structure, and the model data here may correspond to the audio-and-video draft. That is to say, the draft model may be understood as a data model. In some embodiments, the audio-and-video model data 460 is a set of comprehensive data associated with the editing of the audio-and-video during the editing process of the audio-and-video, the set of comprehensive data includes original data, editing data, metadata, preview data, etc. of the audio-and-video, and the audio-and-video model data may include multiple materials, for example, these materials may be various materials such as video, text, audio, picture in picture, and effects.

In some embodiments, the model conversion service 440 may be used for requesting the model management service 450 to acquire the current audio-and-video model data, or a copy of the model data. In some embodiments, the model management service 450 is mainly used for providing the model conversion service with thread-safe audio-and-video model data. Each time the user completes an interface operation, a copy of the audio-and-video model data may be saved, and the copy is read-only, thereby being able to avoid the data confusion problem caused by multi-threaded read and write concurrency.

In combination with the description of FIG. 3A, in some embodiments, after the user triggers the user interaction of "swap positions", the interface request data 421 related to this interaction may be processed and transformed by the request data configuration center 430 and then input into the model conversion service 440. Next, the model conversion service 440 may configure the service request data to obtain the model data acquisition request sent to the model management service 450, because the model conversion service 440 may parse the corresponding model data acquisition request for each user’s interactive behavior. In some embodiments, the model conversion service 440 has a predefined parsing table for parsing the corresponding model data acquisition request according to the user’s interaction.

Thus, in some embodiments, after the model conversion service 450 sends the model data acquisition request to the model management service 450, the model management service 450 may transmit the current audio-and-video model data (a copy thereof) to the model conversion service 440, so that the model conversion service 440 may output the incremental structure 470 of the model data, that is, the second data, based on the interface request data 421, that is, the first data.

In combination with FIG. 3A, the service request data corresponding to the user’s interactive operation is "swap positions, video A, video B", and the service request data may be mapped to the corresponding audio-and-video model data. In some embodiments, the data structure of the model data of the audio-and-video draft includes: an identification (res) for describing the material resource, a tag (id) for describing the material resource, a type (type) for describing the material resource, and a time range (timeRange) for describing the material resource. Then, the "swap positions, video A, video B" may be transformed by the model conversion service 440 into an incremental structure of two audio-and-video draft models. In some embodiments, the incremental structure may be identified using serialized text, such as text in JSON or XML format.

In some embodiments, the data structure of the model data of the audio-and-video may be as follows:

Model 1 (before swapping positions): there exist two res, the first res type is video, id is A, and timeRange is 0-6s; the second res type is video, id is B, and timeRange is 6-15s.

Model 2 (after swapping positions): there exist two res, the first res type is video, id is B, and timeRange is 0-9s; the second res type is video, id is A, and timeRange is 9-15s.

Referring to FIG. 4, in some embodiments, the incremental structure 470 is read-only to avoid the problem of read and write confusion caused by multi-thread concurrency, that is, the incremental structure 470 is thread-independent. In some embodiments, after the model conversion service 440 outputs the incremental structure 470, the incremental structure 470 may be used for implementing business interface refreshing 480, that is, the incremental structure may be passed to the user’s business interface such as the editing interface, at this time, the business interface may recognize the incremental change caused by the user behavior this time, so that the interface refreshing logic may be triggered by the business logic.

In combination with FIG. 3A and FIG. 3B, after receiving the incremental structure (model 2), the business interface, that is, the editing interface, may recognize the used interface element according to the tag of the material resource in the incremental structure, thereby modifying the layout and display effect of the corresponding interface element on the interface according to the time range used for describing the material resource. As shown in FIG. 3B, the main track clip 307 and the main track clip 306 are filled in the video track 303-1 from left to right, and the texts linked with the two main track clips are also moved accordingly.

By placing the audio-and-video model data for supporting the audio-and-video editing interface refreshing in the asynchronous thread, the frequency of the interface freezing phenomenon may be effectively reduced when the user interacts with the editing interface, thereby improving the fluency of the user’s interaction with the interface.

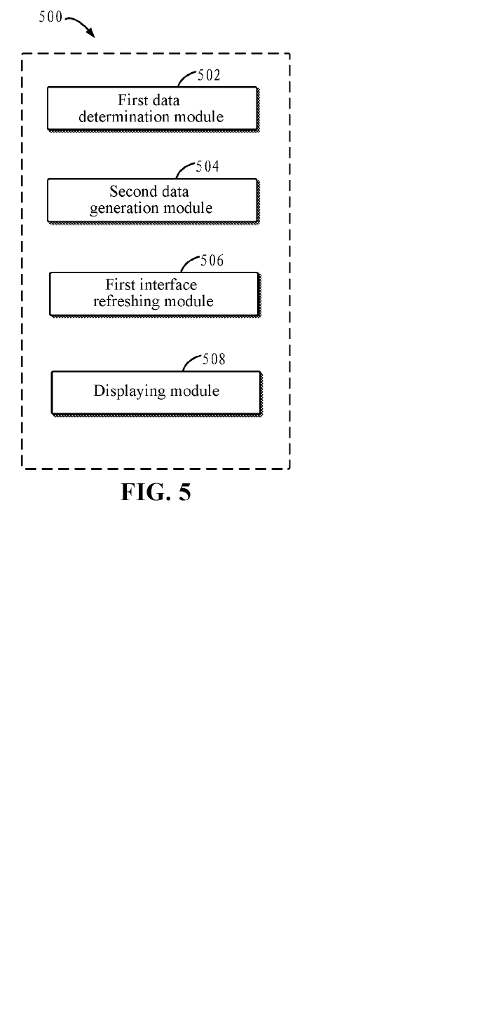

FIG. 5 shows a block diagram of an apparatus 500 for displaying a visual template package according to some embodiments of the present disclosure. As shown in FIG. 5, the apparatus 500 includes a first data determination module 502 configured to determine, in response to detecting a user’s interactive operation for a first interface, first data, wherein the first interface is used for editing an audio-and-video, and the first data indicates data for refreshing the first interface and corresponding to the interactive operation. The apparatus 500 further includes a second data generation module 504 configured to generate second data based on the first data and model data of the audio-and-video. The apparatus 500 includes a first interface refreshing module 506 configured to refresh the first interface based on the second data, the refreshed first interface being a second interface. In addition, the apparatus 500 further includes a displaying module 508 configured to display the edited audio-and-video on the second interface.

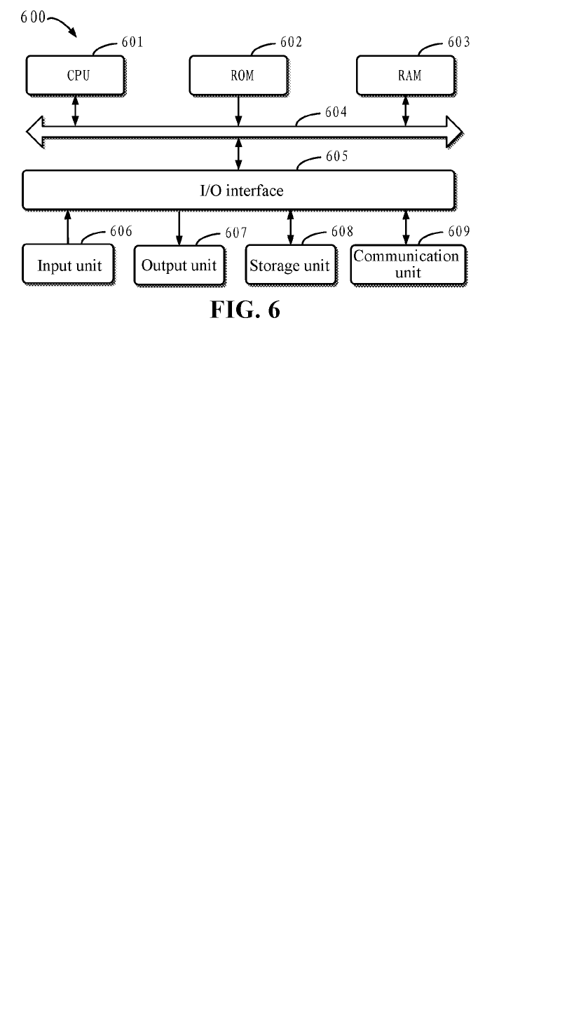

FIG. 6 shows a block diagram of a device 600 capable of implementing multiple embodiments of the present disclosure. As shown in FIG. 6, the device 600 includes a central processing unit (CPU) and/or a graphics processing unit (GPU) 601, which may perform various appropriate actions and processing according to computer program instructions stored in a read-only memory (ROM) 602 or computer program instructions loaded from a storage unit 608 into a random access memory (RAM) 603. In the RAM 603, various programs and data required for the operation of the device 600 may also be stored. The CPU/GPU 601, the ROM 602, and the RAM 603 are connected to each other through a bus 604. An input/output (I/O) interface 605 is also connected to the bus 604. Although not shown in FIG. 6, the device 600 may further include a coprocessor.

Multiple components in the device 600 are connected to the I/O interface 605, including: an input unit 606, such as a keyboard, a mouse, etc.; an output unit 607, such as various types of displays, speakers, etc.; the storage unit 608, such as a magnetic disk, an optical disc, etc.; and a communication unit 609, such as a network card, a modem, a wireless communication transceiver, etc. The communication unit 609 allows the device 600 to exchange information/data with other devices through a computer network such as Internet and/or various telecommunication networks.

The methods or processes described above may be executed by the CPU/GPU 601. For example, in some embodiments, the method may be implemented as a computer software program, which is tangibly contained in a machine-readable medium, such as the storage unit 608. In some embodiments, part or entirety of the computer program may be loaded and/or installed on the device 600 via the ROM 602 and/or the communication unit 606. When the computer program is loaded into the RAM 603 and executed by the CPU/GPU 601, one or more steps or actions in the methods or processes described above may be implemented.

In some embodiments, the methods and processes described above may be implemented as a computer program product. The computer program product may include a computer-readable storage medium having computer-readable program instructions for performing various aspects of the present disclosure stored thereon.

The computer-readable storage medium may be a tangible device that may hold and store instructions used by an instruction execution device. The computer-readable storage medium may be, for example, but not limited to, an electrical storage device, a magnetic storage device, an optical storage device, an electromagnetic storage device, a semiconductor storage device, or any suitable combination of the above. More specific examples (a non-exhaustive list) of the computer-readable storage medium include: a portable computer disk, a hard disk, a random access memory (RAM), a read-only memory (ROM), an erasable programmable read-only memory (EPROM or flash memory), a static random access memory (SRAM), a portable compact disk read-only memory (CD-ROM), a digital versatile disk (DVD), a memory stick, a floppy disk, a mechanically encoded device, such as a punch card or a raised structure in a groove with instructions stored thereon, and any suitable combination of the above. The computer-readable storage medium used herein is not interpreted as an instantaneous signal itself, such as a radio wave or other freely propagating electromagnetic wave, an electromagnetic wave propagating through a waveguide or other transmission medium (for example, an optical pulse through an optical fiber cable), or an electrical signal transmitted through a wire.

The computer-readable program instructions described herein may be downloaded from the computer-readable storage medium to various computing/processing devices, or downloaded to an external computer or an external storage device through a network, such as Internet, a local area network, a wide area network, and/or a wireless network. The network may include a copper transmission cable, an optical fiber transmission, a wireless transmission, a router, a firewall, a switch, a gateway computer, and/or an edge server. The network adapter card or network interface in each computing/processing device receives the computer-readable program instructions from the network and forwards the computer-readable program instructions for storage in the computer-readable storage medium in each computing/processing device.

The computer program instructions for performing the operations of the present disclosure may be assembly instructions, instruction set architecture (ISA) instructions, machine instructions, machine-related instructions, microcode, firmware instructions, state setting data, or source code or object code written in any combination of one or more programming languages, including object-oriented programming languages and conventional procedural programming languages. The computer-readable program instructions may be executed entirely on a user's computer, partly on the user's computer, as a stand-alone software package, partly on the user's computer and partly on a remote computer, or entirely on the remote computer or a server. In the case of involving the remote computer, the remote computer may be connected to the user's computer through any kind of network, including a local area network (LAN) or a wide area network (WAN), or it may be connected to an external computer (for example, connected by using Internet provided by an Internet service provider). In some embodiments, by customizing an electronic circuit, such as a programmable logic circuit, a field programmable gate array (FPGA) or a programmable logic array (PLA), with the state information of the computer-readable program instructions, the electronic circuit may execute the computer-readable program instructions, thereby implementing various aspects of the present disclosure.

These computer-readable program instructions may be provided to the processing unit of a general-purpose computer, a special-purpose computer, or other programmable data processing apparatus to produce a machine, so that when these instructions are executed by the processing unit of the computer or other programmable data processing apparatus, an apparatus for implementing the functions/actions specified in one or more blocks in the flowcharts and/or block diagrams is produced. These computer-readable program instructions may also be stored in a computer-readable storage medium, these instructions make the computer, the programmable data processing apparatus, and/or other devices work in a specific way, thus, the computer-readable medium storing the instructions includes a manufactured product, which includes instructions for implementing various aspects of the functions/actions specified in one or more blocks in the flowcharts and/or block diagrams.

The computer-readable program instructions may also be loaded onto a computer, other programmable data processing apparatus, or other devices, so that a series of operation steps are performed on the computer, other programmable data processing apparatus, or other devices to produce a computer-implemented process, so that the instructions executed on the computer, other programmable data processing apparatus, or other devices implement the functions/actions specified in one or more blocks in the flowcharts and/or block diagrams.

The flowcharts and block diagrams in the drawings show the possibly implemented architectures, functions, and operations of the device, the method, and the computer program product according to multiple embodiments of the present disclosure. In this regard, each block in the flowcharts or block diagrams may represent a module, program segment, or part of an instruction, and the module, program segment, or part of an instruction contains one or more executable instructions for implementing the specified logical functions. In some alternative implementations, the functions marked in the blocks may also occur in an order different from that marked in the drawings. For example, two consecutive blocks may actually be performed substantially in parallel, or they may sometimes be performed in the reverse order, depending on the functions involved. It should also be noted that each block in the block diagrams and/or flowcharts, and a combination of the blocks in the block diagrams and/or flowcharts may be implemented by a special-purpose hardware-based system that executes specified functions or actions, or may be implemented by a combination of special-purpose hardware and computer instructions.

The embodiments of the present disclosure have been described above, and the above description is exemplary, non-exhaustive, and not limited to the disclosed embodiments. Without departing from the scope and spirit of the described embodiments, many modifications and changes will be apparent to those of ordinary skill in the art. The terms used herein are chosen to best explain the principles of the embodiments, the actual application or the technical improvement of the technology in the market, or to enable other ordinary skilled persons in the art to understand the embodiments disclosed herein.

Some example implementations of the present disclosure are listed below.

Example 1. A method for refreshing an interface, including:

determining, in response to detecting a user’s interactive operation for a first interface, first data, the first interface being used for editing an audio-and-video, and the first data indicating data for refreshing the first interface and corresponding to the interactive operation;

generating second data based on the first data and model data of the audio-and-video;

refreshing the first interface based on the second data , the refreshed first interface being a second interface; and

displaying the edited audio-and-video on the second interface.

Example 2. The method according to Example 1, the model data indicates a set of comprehensive data cached during an editing process of the audio-and-video and associated with the editing process of the audio-and-video, the set of comprehensive data including at least one of original data, editing data, metadata, or preview data of the audio-and-video.

Example 3. The method according to any one of Examples 1-2, determining, in response to detecting the user’s interactive operation for the first interface, the first data includes:

determining, in response to detecting the interactive operation, the user’s interactive behavior; and

determining the first data based on the interactive behavior.

Example 4. The method according to any one of Examples 1-3, the first data includes a behavior description and a material set corresponding to the interactive operation, and the method further includes:

determining the behavior description corresponding to the interactive behavior, the behavior description indicating interactive logic of the user’s interactive operation for the first interface; and

determining an audio-and-video material set corresponding to the interactive behavior, the audio-and-video material set indicating a material resource required by the interactive logic.

Example 5. The method according to any one of Examples 1-4, generating the second data based on the first data and the model data of the audio-and-video includes:

acquiring the model data of the audio-and-video in the first interface; and

configuring the first data and the model data of the audio-and-video to generate the second data, the second data corresponding to the interactive operation.

Example 6. The method according to any one of Examples 1-4, acquiring the model data of the audio-and-video includes:

determining a model data acquisition request based on the first data, the model data acquisition request being used for acquiring the model data of the audio-and-video; and

acquiring the model data of the audio-and-video based on the model data acquisition request.

Example 7. The method according to any one of Examples 1-6, configuring the first data and the model data of the audio-and-video to generate the second data includes:

determining a data structure of the model data of the audio-and-video based on the model data of the audio-and-video; and

generating the second data based on the data structure, the behavior description, and the material set.

Example 8. The method of any of Examples 1-7, the data structure includes at least one of: an identification for describing the material resource, a tag for describing the material resource, a type for describing the material resource, or a time range for describing the material resource.

Example 9. The method of any of Examples 1-8, the audio-and-video includes a first material, the interactive operation is used for editing the first material, and the model data includes a material resource of the first material and/or an identifier of the first material.

Example 10. The method of any of Examples 1-9, refreshing the first interface based on the second data includes:

parsing, in response to detecting the generation of the second data, the second data; and

refreshing the first interface based on the parsed second data.

Example 11. The method of any of Examples 1-10, a thread for generating the second data and a thread for refreshing the first interface are different threads.

Example 12. The method of any of Examples 1-11, refreshing the first interface based on the parsed second data includes:

determining an identification of a refreshed material resource in the first interface based on the parsed second data; and

determining, in the first interface, an interface element corresponding to the identification based on the identification to refresh the first interface, the refreshed first interface being the second interface.

Example 13. The method of any of Examples 1-12, further including:

saving, in response to detecting the refreshing of the first interface, a copy of refreshed model data of the audio-and-video, the copy being a read-only type.

Example 14. An apparatus for refreshing an interface, including:

a first data determination module configured to determine, in response to detecting a user’s interactive operation for a first interface, first data, the first interface being used for editing an audio-and-video, and the first data indicating data for refreshing the first interface and corresponding to the interactive operation;

a second data generation module configured to generate second data based on the first data and model data of the audio-and-video;

a first interface refreshing module configured to refresh the first interface based on the second data , the refreshed first interface being a second interface; and

a displaying module configured to display the edited audio-and-video on the second interface.

Example 15. The apparatus of Example 14, the model data indicates a set of comprehensive data cached during an editing process of the audio-and-video and associated with the editing process of the audio-and-video, the set of comprehensive data including at least one of original data, editing data, metadata, or preview data of the audio-and-video.

Example 16. The apparatus of any of Examples 14-15, the first data determination module includes:

a first determination module configured to determine, in response to detecting the interactive operation, the user’s interactive behavior; and

a second determination module configured to determine the first data based on the interactive behavior.

Example 17. The apparatus of any of Examples 14-16, the first data includes a behavior description and a material set corresponding to the interactive operation, and the apparatus further includes:

a third determination module configured to determine the behavior description corresponding to the interactive behavior, the behavior description indicating interactive logic of the user’s interactive operation for the first interface; and

a fourth determination module configured to determine an audio-and-video material set corresponding to the interactive behavior, the audio-and-video material set indicating a material resource required by the interactive logic.

Example 18. The apparatus of any of Examples 14-17, the second data generation module includes:

a first acquisition module configured to acquire the model data of the audio-and-video in the first interface; and

a configuration module configured to configure the first data and the model data of the audio-and-video to generate the second data, the second data corresponding to the interactive operation.

Example 19. The apparatus of any of Examples 14-18, the first acquisition module includes:

a fifth determination module configured to determine a model data acquisition request based on the first data, the model data acquisition request being used for acquiring the model data of the audio-and-video; and

a second acquisition module configured to acquire the model data of the audio-and-video based on the model data request.

Example 20. The apparatus of any of Examples 14-19, the configuration module includes:

a sixth determination module configured to determine a data structure of the model data of the audio-and-video based on the model data of the audio-and-video; and

a first generation module configured to generate the second data based on the data structure, the behavior description, and the material set.

Example 21. The apparatus of any of Examples 14-20, the data structure includes at least one of: an identification for describing the material resource, a tag for describing the material resource, a type for describing the material resource, or a time range for describing the material resource.

Example 22. The apparatus of any of Examples 14-21, the audio-and-video includes a first material, the interactive operation is used for editing the first material, and the model data includes a material resource of the first material and/or an identifier of the first material.

Example 23. The apparatus of any of Examples 14-22, the first interface refreshing module includes:

a parsing module configured to parse, in response to detecting the generation of the second data, the second data; and

a refreshing module configured to refresh the first interface based on the parsed second data.

Example 24. The apparatus of any of Examples 14-23, a thread for generating the second data and a thread for refreshing the first interface are different threads.

Example 25. The apparatus of any of Examples 14-24, the refreshing module includes:

a seventh determination module configured to determine an identification of a refreshed material resource in the first interface based on the parsed second data; and

an eighth determination module configured to determine, in the first interface, an interface element corresponding to the identification based on the identification to refresh the first interface, the refreshed first interface being the second interface.

Example 26. The apparatus of any of Examples 14-25, further including:

a saving module configured to save, in response to detecting the refreshing of the first interface, a copy of refreshed model data of the audio-and-video, the copy being a read-only type.

Example 27. An electronic device, including:

a processor; and

a memory coupled with the processor, the memory having instructions stored therein, the instructions, when executed by the processor, causing the electronic device to perform actions, the actions including:

determining, in response to detecting a user’s interactive operation for a first interface, first data, the first interface being used for editing an audio-and-video, and the first data indicating data for refreshing the first interface and corresponding to the interactive operation;

generating second data based on the first data and model data of the audio-and-video;

refreshing the first interface based on the second data , the refreshed first interface being a second interface; and

displaying the edited audio-and-video on the second interface.

Example 28. The electronic device of Example 27, the model data indicates a set of comprehensive data cached during an editing process of the audio-and-video and associated with the editing process of the audio-and-video, the set of comprehensive data including at least one of original data, editing data, metadata, or preview data of the audio-and-video.

Example 29. The electronic device of any of Examples 27-28, determining, in response to detecting the user’s interactive operation for the first interface, the first data includes:

determining, in response to detecting the interactive operation, the user’s interactive behavior; and

determining the first data based on the interactive behavior.

Example 30. The electronic device of any of Examples 27-29, the first data includes a behavior description and a material set corresponding to the interactive operation, and the electronic device further includes:

determining the behavior description corresponding to the interactive behavior, the behavior description indicating interactive logic of the user’s interactive operation for the first interface; and

determining an audio-and-video material set corresponding to the interactive behavior, the audio-and-video material set indicating a material resource required by the interactive logic.

Example 31. The electronic device of any of Examples 27-30, generating the second data based on the first data and the model data of the audio-and-video includes:

acquiring the model data of the audio-and-video in the first interface; and

configuring the first data and the model data of the audio-and-video to generate the second data, the second data corresponding to the interactive operation.

Example 32. The electronic device of any of Examples 27-31, acquiring the model data of the audio-and-video includes:

determining a model data acquisition request based on the first data, the model data acquisition request being used for acquiring the model data of the audio-and-video; and

acquiring the model data of the audio-and-video based on the model data request.

Example 33. The electronic device of any of Examples 27-32, configuring the first data and the model data of the audio-and-video to generate the second data includes:

determining a data structure of the model data of the audio-and-video based on the model data of the audio-and-video; and

generating the second data based on the data structure, the behavior description, and the material set.

Example 34. The electronic device of any of Examples 27-33, the data structure includes at least one of: an identification for describing the material resource, a tag for describing the material resource, a type for describing the material resource, or a time range for describing the material resource.

Example 35. The electronic device of any of Examples 27-34, the audio-and-video includes a first material, the interactive operation is used for editing the first material, and the model data includes a material resource of the first material and/or an identifier of the first material.

Example 36. The electronic device of any of Examples 27-35, refreshing the first interface based on the second data includes:

parsing, in response to detecting the generation of the second data, the second data; and

refreshing the first interface based on the parsed second data.

Example 37. The electronic device of any of Examples 27-36, a thread for generating the second data and a refreshing thread of the editing interface are different threads.

Example 38. The electronic device of any of Examples 27-37, refreshing the first interface based on the parsed second data includes:

determining an identification of a refreshed material resource in the first interface based on the parsed second data; and

determining, in the first interface, an interface element corresponding to the identification based on the identification to refresh the first interface, the refreshed first interface being the second interface.

Example 39. The electronic device of any of Examples 27-38, further including:

saving, in response to detecting the refreshing of the first interface, a copy of refreshed model data of the audio-and-video, the copy being a read-only type.

Example 40. A computer-readable storage medium having computer-executable instructions stored thereon, wherein the computer-executable instructions are executed by a processor to implement the method of any of Examples 1-13.

Example 41. A computer program product tangibly stored on a computer-readable medium and including computer-executable instructions that, when executed by a device, cause the device to perform the method of any of Examples 1-13.

Although the present disclosure has been described in a language specific to structural features and/or logical actions of the method, it should be understood that the subject matter defined in the appended claims is not necessarily limited to the specific features or actions described above. On the contrary, the specific features and actions described above are only example forms for implementing the claims.

We claim:

1. A method for refreshing an interface, comprising:
determining, in response to detecting a user’s interactive operation for a first interface, first data, the first interface being used for editing an audio-and-video, and the first data indicating data for refreshing the first interface and corresponding to the interactive operation;
generating second data based on the first data and model data of the audio-and-video;
refreshing the first interface based on the second data , the refreshed first interface being a second interface; and
displaying the edited audio-and-video on the second interface.

2. The method of claim 1, wherein the model data indicates a set of comprehensive data cached during an editing process of the audio-and-video and associated with the editing process of the audio-and-video, the set of comprehensive data comprises at least one of original data, editing data, metadata, or preview data of the audio-and-video.

3. The method of claim 1, wherein determining, in response to detecting the user’s interactive operation for the first interface, the first data comprises:
determining, in response to detecting the interactive operation, the user’s interactive behavior; and
determining the first data based on the interactive behavior.

4. The method of claim 3, wherein the first data comprises a behavior description and a material set corresponding to the interactive operation, and the method further comprises:
determining the behavior description corresponding to the interactive behavior, the behavior description indicating interactive logic of the user’s interactive operation for the first interface; and
determining an audio-and-video material set corresponding to the interactive behavior, the audio-and-video material set indicating a material resource required by the interactive logic.

5. The method of claim 4, wherein generating the second data based on the first data and the model data of the audio-and-video comprises:
acquiring the model data of the audio-and-video in the first interface; and
configuring the first data and the model data of the audio-and-video to generate the second data, the second data corresponding to the interactive operation.

6. The method of claim 5, wherein acquiring the model data of the audio-and-video comprises:
determining a model data acquisition request based on the first data, the model data acquisition request being used for acquiring the model data of the audio-and-video; and
acquiring the model data of the audio-and-video based on the model data request.

7. The method of claim 6, wherein configuring the first data and the model data of the audio-and-video to generate the second data comprises:
determining a data structure of the model data of the audio-and-video based on the model data of the audio-and-video; and
generating the second data based on the data structure, the behavior description, and the material set.

8. The method of claim 7, wherein the data structure comprises at least one of: an identification for describing the material resource, a tag for describing the material resource, a type for describing the material resource, or a time range for describing the material resource.

9. The method of claim 8, wherein the audio-and-video comprises a first material, the interactive operation is used for editing the first material, and the model data comprises a material resource of the first material and/or an identifier of the first material.

10. The method of claim 1, wherein refreshing the first interface based on the second data comprises:
parsing, in response to detecting the generation of the second data, the second data; and
refreshing the first interface based on the parsed second data.

11. The method of claim 10, wherein a thread for generating the second data and a thread for refreshing the first interface are different threads.

12. The method of claim 11, wherein refreshing the first interface based on the parsed second data comprises:
determining an identification of a refreshed material resource in the first interface based on the parsed second data; and
determining, in the first interface, an interface element corresponding to the identification based on the identification to refresh the first interface, the refreshed first interface being the second interface.

13. The method of claim 1, further comprising:
saving, in response to detecting the refreshing of the first interface, a copy of refreshed model data of the audio-and-video, the copy being a read-only type.

14. An electronic device, comprising:
a processor; and
a memory coupled with the processor, the memory having instructions stored therein, the instructions, when executed by the processor, causing the electronic device to perform a method for refreshing an interface comprising:
determining, in response to detecting a user’s interactive operation for a first interface, first data, the first interface being used for editing an audio-and-video, and the first data indicating data for refreshing the first interface and corresponding to the interactive operation;
generating second data based on the first data and model data of the audio-and-video;
refreshing the first interface based on the second data , the refreshed first interface being a second interface; and
displaying the edited audio-and-video on the second interface.

15. The electronic device of claim 14, wherein the model data indicates a set of comprehensive data cached during an editing process of the audio-and-video and associated with the editing process of the audio-and-video, the set of comprehensive data comprises at least one of original data, editing data, metadata, or preview data of the audio-and-video.

16. The electronic device of claim 14, wherein determining, in response to detecting the user’s interactive operation for the first interface, the first data comprises:
determining, in response to detecting the interactive operation, the user’s interactive behavior; and
determining the first data based on the interactive behavior.

17. The electronic device of claim 16, wherein the first data comprises a behavior description and a material set corresponding to the interactive operation, and the method further comprises:
determining the behavior description corresponding to the interactive behavior, the behavior description indicating interactive logic of the user’s interactive operation for the first interface; and
determining an audio-and-video material set corresponding to the interactive behavior, the audio-and-video material set indicating a material resource required by the interactive logic.

18. The electronic device of claim 17, wherein generating the second data based on the first data and the model data of the audio-and-video comprises:
acquiring the model data of the audio-and-video in the first interface; and
configuring the first data and the model data of the audio-and-video to generate the second data, the second data corresponding to the interactive operation.

19. The electronic device of claim 18, wherein acquiring the model data of the audio-and-video comprises:
determining a model data acquisition request based on the first data, the model data acquisition request being used for acquiring the model data of the audio-and-video; and
acquiring the model data of the audio-and-video based on the model data request.

20. A computer program product comprising computer-executable instructions, wherein the computer-executable instructions are executed by a processor to implement a method for refreshing an interface comprising:
determining, in response to detecting a user’s interactive operation for a first interface, first data, the first interface being used for editing an audio-and-video, and the first data indicating data for refreshing the first interface and corresponding to the interactive operation;
generating second data based on the first data and model data of the audio-and-video;
refreshing the first interface based on the second data , the refreshed first interface being a second interface; and
displaying the edited audio-and-video on the second interface.
